(19) United States
(12) Patent Application Publication
(10) Pub. No.: US 2022/0181624 A1
(43) Pub. Date: Jun. 9, 2022

(54) LOW POROSITY ELECTRODES AND RELATED METHODS

(71) Applicant: Sion Power Corporation, Tucson, AZ (US)

(72) Inventors: Yuriy V. Mikhaylik, Tucson, AZ (US); Igor P. Kovalev, Vail, AZ (US); Chariclea Scordilis-Kelley, Tucson, AZ (US); Urs Schoop, Tucson, AZ (US)

(73) Assignee: Sion Power Corporation, Tucson, AZ (US)

(21) Appl. No.: 17/540,611

(22) Filed: Dec. 2, 2021

Related U.S. Application Data
(60) Provisional application No. 63/121,265, filed on Dec. 4, 2020.

(51) Int. Cl. H01M 4/58; H01M 4/62; H01M 4/66; H01M 4/38; H01M 4/04

(52) U.S. Cl. CPC H01M 4/581; H01M 4/623; H01M 4/625; H01M 2004/021; H01M 4/382; H01M 4/0402; H01M 4/661

(57) ABSTRACT

Electrodes and methods of preparing electrodes with a porous electroactive region are generally described herein.

### RELATED APPLICATIONS

This application claims priority under 35 U.S.C. § 119(e) to U.S. Provisional Patent Application No. 63/121,265, filed Dec. 4, 2020, and entitled “Low Porosity Electrodes and Related Methods,” which is incorporated herein by reference in its entirety for all purposes.

### TECHNICAL FIELD

Low porosity electrodes and related methods are generally described.

### BACKGROUND

A typical electrochemical cell can include a cathode and an anode which participate in an electrochemical reaction. Generally, electrochemical reactions are facilitated by an electrolyte, which can contain an electroactive species, such as lithium ions, and may also behave as an electrically conductive medium.

### SUMMARY

Low porosity electrodes and related methods are generally described. The subject matter of the present invention involves, in some cases, interrelated products, alternative solutions to a particular problem, and/or a plurality of different uses of one or more systems and/or articles.

Certain aspects are related to electrodes. In some embodiments, the electrode comprises a porous electroactive region, the porous electroactive region comprising: a lithium intercalation compound, and an electronically conductive material; wherein the porous electroactive region has a porosity of less than or equal to 16%.

In certain embodiments, the electrode comprises a porous electroactive region, the porous electroactive region comprising: a lithium intercalation compound, and an electronically conductive material; wherein the porous electroactive region has an average cross-sectional pore diameter of less than or equal to 200 nanometers.

Electrochemical cells are also described. In some embodiments, the electrochemical cell comprises a first electrode comprising a porous electroactive region, the porous electroactive region comprising a lithium intercalation compound and an electronically conductive material, wherein the porous electroactive region has a porosity of less than or equal to 16%; a second electrode; and an electrolyte in electrochemical communication with the first electrode and the second electrode.

In certain embodiments, the electrochemical cell comprises a first electrode comprising a porous electroactive region, the porous electroactive region comprising a lithium intercalation compound and an electronically conductive material, wherein the porous electroactive region has an average cross-sectional pore diameter of less than or equal to 200 nanometers; a second electrode; and an electrolyte in electrochemical communication with the first electrode and the second electrode.

Methods of preparing electrodes are also described. In some embodiments, a method of preparing an electrode comprising a porous electroactive region comprises depositing a lithium intercalation compound and an electronically conductive material onto a substrate to form a deposit, wherein the porous electroactive region has a porosity of less than or equal to 16%.

In certain embodiments, a method of preparing an electrode comprising a porous electroactive region comprises depositing a lithium intercalation compound and an electronically conductive material onto a substrate to form a deposit, wherein the porous electroactive region has an average cross-sectional pore diameter of less than or equal to 200 nanometers.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIGS. 1A-1F are cross-sectional schematic illustrations showing a method of preparing a porous electrode, according to some embodiments;

FIG. 2 is a cross-sectional schematic illustration of an electrode comprising a porous electroactive region, according to some embodiments;

FIG. 3 is a cross-sectional schematic illustration of an electrochemical cell containing an electrode with a porous electroactive region, according to some embodiments;

FIG. 4 shows a cross sectional schematic diagram of an exemplary electric vehicle comprising a battery, according to some embodiments; and

FIG. 5 is a plot of cycle life as a function of cathode porosity, according to one set of embodiments.

### DETAILED DESCRIPTION

Electrodes comprising porous electroactive regions having low porosities are described herein. Also provided are methods for preparing low porosity electrodes.

Previously, it was generally believed that the use of high porosity electrodes would enhance electrochemical cell performance due to enhanced contact between the electrolyte and the electrode active material within the electrode. For example, high porosity electrodes were expected to enhance lithium ion transport in lithium ion secondary batteries. However, it has been unexpectedly discovered within the context of the present disclosure that the use of a lithium intercalation electrode having a low porosity can lead to improved performance of the electrochemical cell. For example, it has been unexpectedly discovered that the use of low porosity electrodes (e.g., electrodes comprising electroactive regions having porosities of less than or equal to 16%) can lead to higher electrochemical cell cycle life, compared to electrochemical cells with electroactive regions having higher porosities.

In some embodiments, a method of preparing an electrode with a porous electroactive region is described. These methods may be used, in accordance with certain embodiments, to produce electrodes comprising electroactive regions having low porosities (e.g., porosities of less than or equal to 16%).

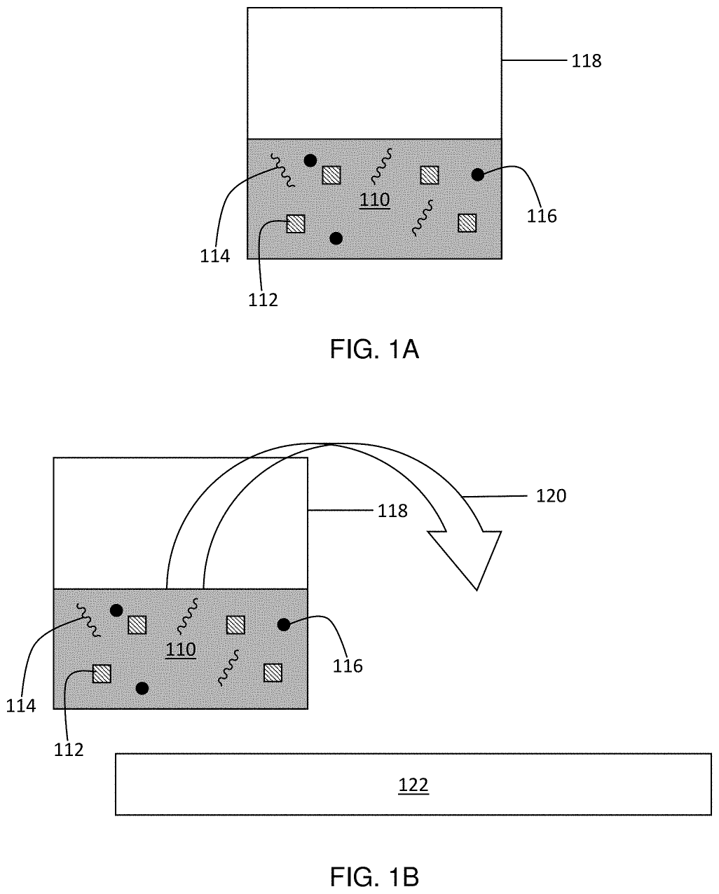

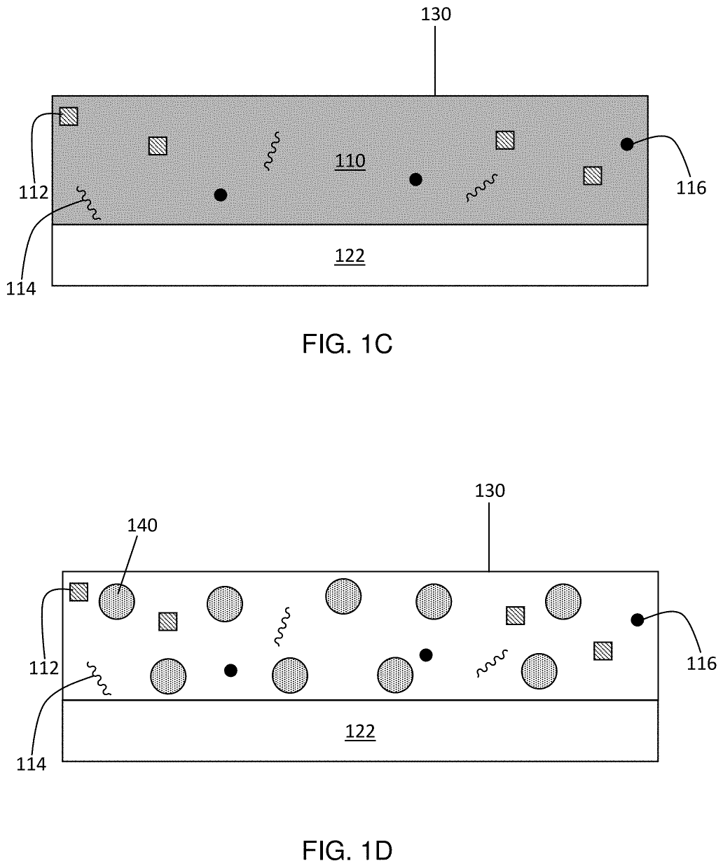

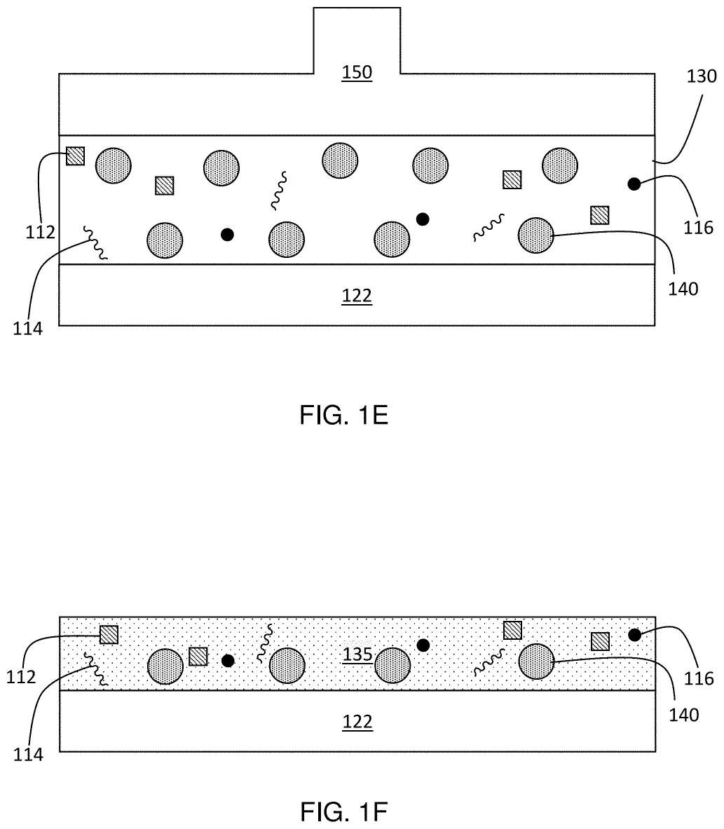

FIGS. 1A-1F are cross-sectional schematic illustrations showing a method of preparing an electrode with a porous electroactive region, according to some embodiments. In some embodiments, the method comprises depositing a lithium intercalation compound and an electronically conductive material onto a substrate to form a deposit. In certain embodiments, a binder can also be included in the material being deposited. In some embodiments, a liquid can also be included in the material being deposited (with or without binder).

In some embodiments, the lithium intercalation compound and the electronically conductive material can first be combined and subsequently be deposited on the substrate. In some such embodiments, binder may also be combined with the lithium intercalation compound and the electronically conductive material prior to deposit. In certain such embodiments, liquid may also be combined with the lithium intercalation compound and the electronically conductive material (and, in some cases, binder) prior to deposit. One example of this type of depositing is shown in FIGS. 1A-1B, described in more detail below. It should be understood, however, that the invention is not so limited, and in other embodiments, one or more of these components (i.e., the lithium intercalation compound, the electronically conductive material, the binder, and/or the liquid) can be deposited separately from one or more of the other components, and the combination can be formed on the substrate.

In some embodiments in which liquid is present, the liquid may form a slurry containing the lithium intercalation compound and/or the electronically conductive material. The slurry may also comprise a binder. For example, FIG. 1A schematically depicts a liquid 110 that contains lithium intercalation compound 112 and electronically conductive material 116. In FIG. 1A, binder 114 is also present. The combination of these components is contained in container 118. The combination of lithium intercalation compound 112 and electronically conductive material 116 can be deposited (via deposition 120) onto substrate 122, as shown in FIG. 1B. After deposition 120, deposit 130 is formed adjacent to substrate 122, schematically illustrated in FIG. 1C.

While the embodiments shown in FIG. 1A-1C include a liquid as part of the initial deposit, it should be understood that in other embodiments, the liquid may be absent, and the lithium intercalation compound and the electronically conductive material may be deposited without any liquid present. In some embodiments, lithium intercalation compound, electronically conductive material, and binder may be deposited without any liquid present.

As described above, the methods described herein may involve depositing materials over a substrate, and the electrodes described herein may include a substrate. As known in the art, substrates are useful as a support on which to deposit electroactive materials and/or slurries and may also provide additional stability for handling of the electrode during electrochemical cell fabrication. Further, in the case of conductive substrates, a substrate may also function as a current collector, which is useful in efficiently collecting the electrical current generated by the electrode and in providing an efficient surface for attachment of electrical contacts leading to an external circuit. A wide range of substrates are known in the art. Suitable substrates include, but are not limited to, metal foils (e.g., aluminum foil), polymer films, metallized polymer films, electrically conductive polymer films, polymer films having an electrically conductive coating, electrically conductive polymer films having an electrically conductive metal coating, and polymer films having conductive particles dispersed therein. Other suitable substrates are also possible.

In some embodiments in which liquid is present in the deposit, the method of preparing the electrode also comprises removing at least a portion of the liquid from the deposit to form the porous electroactive region of the electrode. For example, as schematically depicted in FIG. 1D, in comparison to FIG. 1C, at least a portion of the liquid 110 has been removed from deposit 130 to form deposit 130 in FIG. 1D. In some embodiments, this deposit can provide the porous electroactive region of the electrode. In other embodiments, the deposit is further processed to form the electroactive region of the electrode.

In embodiments in which a liquid is included in the deposit, any suitable method can be used to remove at least a portion of the liquid. In some embodiments, the removing comprises evaporation. For example, evaporating the liquid in an oven and/or under reduced pressure (e.g., a vacuum) may be suitable for removing at least a portion of the liquid. In some embodiments, removing at least a portion of the liquid may be achieved under ambient conditions by exposure to the surrounding environment. In some cases, a liquid (such as a low molecular weight alcohol, e.g., isopropanol) can be used extract and remove at least a portion of another liquid in the deposit. In some embodiments, a supercritical fluid (e.g., supercritical carbon dioxide) may be used to remove at least a portion of the liquid from the deposit.

In some embodiments, removing at least a portion of the liquid from the deposit comprises removing greater than or equal to 90 wt %, greater than or equal to 95 wt %, greater than or equal to 98 wt %, greater than or equal to 99 wt %, greater than or equal to 99.9 wt %, or more of the liquid from the deposit. In some embodiments, removing liquid from the deposit comprises removing less than or equal to 99.9 wt %, less than or equal to 99 wt %, less than or equal to 98 wt %, less than or equal to 95 wt %, or less of the liquid from the deposit. Combinations of the above-referenced ranges are also possible (e.g., at least 90 wt % and less than or equal to 99.9 wt %). Other ranges are also possible.

When a liquid is present in the deposit, the liquid can be any of a variety of suitable liquids (e.g., a solvent) for dissolving and/or suspending the components of the deposit. In some embodiments, the liquid is a solvent for (i.e., dissolves) one or more components of the deposit. The liquid may be substantially unreactive with the other components of the deposit (e.g., lithium intercalation compound, binder). The liquid may be non-aqueous, aqueous, or a mixture thereof. Examples of non-aqueous liquids include, but are not limited to, non-aqueous organic solvents, such as, for example, N-methyl acetamides, such as dimethylacetaminde (DMAc), acetonitrile, acetals, ketals, esters (e.g., butanone), carbonates (e.g., fluoroethylene carbonate, dimethyl carbonate), sulfones, sulfites, sulfolanes, aliphatic ethers, acyclic ethers, cyclic ethers, glymes, alcohols (e.g., methanol, ethanol, isopropanol), polyethers, phosphate esters, siloxanes, dioxolanes, N-alkylpyrrolidones, such as N-methyl-2-pyrrolidone (NMP), substituted forms of the foregoing, and blends thereof. Examples of acyclic ethers that may be used include, but are not limited to, diethyl ether, dipropyl ether, dibutyl ether, dimethoxymethane (DME), trimethoxymethane, dimethoxyethane, diethoxyethane, 1,2-dimethoxypropane, and 1,3-dimethoxypropane. Examples of cyclic ethers that may be used include, but are not limited to, tetrahydrofuran (THF), tetrahydropyran, 2-methyltetrahydrofuran, 1,4-dioxane, 1,3-dioxolane (DOL), and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Mixtures of liquids described herein can also be used.

In some embodiments, the method may also comprise compressing the deposit. For example, in reference to FIG. 1E, deposit 130 is compressed by press 150. In compressing the deposit, the porosity of the porous electroactive region may be altered (e.g., decreased), which can advantageously be used to tune the porosity of the electrode. In some embodiments, compressing the deposit may reduce the porosity of the porous electroactive region of the resultant electrode to less than or equal to 16%. In some embodiments, compressing the deposit may also reduce the pore size (e.g., the average pore diameter) of the resulting electrode, from a first pore size to a second pore size smaller than the first pore size.

In some embodiments, compressing the deposit comprises applying a force (e.g., a pressure) to the deposit and/or the electrode. As one non-limiting example, a hydraulic press can be used to apply a force to the deposit and/or to the electrode. In some embodiments, compressing comprises applying a force of greater than or equal to 0.5 ton/cm², greater than or equal to 1 ton/cm², greater than or equal to 5 ton/cm², greater than or equal to 10 ton/cm², greater than or equal to 20 ton/cm², greater than or equal to 25 ton/cm², greater than or equal to 30 ton/cm², greater than or equal to 40 ton/cm², greater than or equal to 50 ton/cm², greater than or equal to 100 ton/cm², or more. In some embodiments, compressing comprises applying a force of less than or equal to 200 ton/cm², less than or equal to 100 ton/cm², less than or equal to 50 ton/cm², less than or equal to 40 ton/cm², less than or equal to 30 ton/cm², less than or equal to 25 ton/cm², less than or equal to 20 ton/cm², less than or equal to 15 ton/cm², less than or equal to 10 ton/cm², less than or equal to 5 ton/cm², less than or equal to 1 ton/cm², or less. Combinations of the above-referenced ranges are also possible (e.g., greater than or equal to 1 ton/cm² and less than or equal to 200 ton/cm²). Other ranges are possible. Compressing the deposit and/or the electrode can advantageously be used to tune the porosity of the electrode (e.g. the porosity of the electroactive region), for example, by lowering the porosity to or below 16%. However, it should be understood that, in some embodiments, the deposit and/or the electrode are not compressed and may have a porosity at or below 16% without compressing.

In some embodiments, compressing (e.g., applying a pressure to) the deposit and/or the electrode can occur when the deposit (or electrode) is at a particular temperature. In some embodiments, compressing occurs when the deposit (or electrode) is at a temperature of greater than or equal to 20° C., greater than or equal to 25° C., greater than or equal to 50° C., greater than or equal to 75° C., greater than or equal to 100° C., greater than or equal 125° C., greater than or equal to 150° C., greater than or equal to 175° C., greater than or equal to 200° C., or more. In some embodiments, compressing occurs when the deposit (or electrode) is at a temperature of less than or equal to 200° C., less than or equal to 175° C., less than or equal to 150° C., less than or equal to 125° C., less than or equal to 100° C., less than or equal to 75° C., less than or equal to 50° C., less than or equal to 25° C., or less. Combinations of the above-referenced ranges are also possible (e.g., greater than or equal to 20° C. and less than or equal to 175° C.). Other ranges are possible. Compressing at an elevated temperature may advantageously aid in compacting the deposit. For example, the elevated temperature may increase the malleability of one or more components of the deposit (e.g., the binder within the deposit) and may facilitate compression relative to compression at lower temperatures. However, it should be understood that for certain embodiments, compressing occurs at ambient temperature (e.g., room temperature) or lower temperatures.

In some embodiments, the method may further comprise placing the electrode under vacuum. This may facilitate removal of liquid (e.g., residual solvent), if present, in the porous electroactive region (e.g., from the pores of the porous electroactive region) or may otherwise facilitate forming the porous electroactive region. In some embodiments, the method may further comprise heating the deposit and/or the electrode. In some embodiments, the heating step comprises heating the deposit and/or the electrode to greater than or equal to 100° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., or more. In some embodiments, the heating step comprises heating the deposit and/or the electrode to less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less. Combinations of the above-referenced ranges are also possible (e.g., heating to greater than or equal to 100° C. and less than or equal to 200° C.). Other ranges are possible.

The heating step can occur for any suitable duration of time. In some embodiments, the heating step occurs for greater than or equal to 1 hour, greater than or equal to 2 hours, greater than or equal to 4 hours, greater than or equal to 6 hours, greater than or equal to 8 hours, greater than or equal to 10 hours, greater than or equal to 12 hours, greater than or equal to 16 hours, greater than or equal to 20 hours, greater than or equal to 24 hours, or longer. In some embodiments, the heating step occurs for less than or equal to 24 hours, less than or equal to 20 hours, less than or equal to 16 hours, less than or equal to 12 hours, less than or equal to 8 hours, less than or equal to 6 hours, less than or equal to 4 hours, less than or equal to 2 hours, less than or equal to 1 hour, or less. Combinations of the above-referenced ranges are also possible (e.g., greater than or equal to 1 hour and less than or equal to 12 hours).

As mentioned above, while some embodiments describe use of a liquid (e.g., a slurry) to form an electrode with a porous electroactive region, it should be understood that other embodiments may use a liquid-free method to form the porous electrode. In some such embodiments, a mixture (e.g., a solid mixture) of a lithium intercalation compound and an electronically conductive material can be combined without any liquid (e.g., a solvent) present. A binder may or may not be present in this solid mixture. The mixture may be mixed using techniques such as ball milling or grinding (e.g., mortar and pestle). The mixture can than be mechanically compressed (for example, using a hydraulic press or other methods known in the art) on a substrate in order to form an electrode with a porous electroactive region.

The porous electroactive region may contain one or more pores. For example, as shown in FIGS. 1D-1F, deposit 130 (and porous electrode 135) contains pores 140. In some embodiments, the pores of the electroactive region may have a relatively small pore size, compared to conventional electrodes. For example, in some embodiments, the porous electroactive region has an average cross-sectional pore diameter of less than or equal to 200 nanometers.

As used herein, a “pore” generally refers to a conduit, void, or passageway at least partially surrounded by a solid material and capable of being occupied by a liquid or gas. For the purposes of this disclosure, voids within a material that are completely surrounded by the material (and thus, not accessible from outside the material, e.g., closed cells) are not considered pores. It should be understood that, in cases where an article or electrode comprises an agglomeration of particles, pores include both the interparticle pores (i.e., those pores defined between particles when they are packed together, e.g. interstices) and intraparticle pores (i.e., those pores lying within the envelopes of the individual particles). Pores may comprise any suitable cross-sectional shape such as, for example, circular, elliptical, polygonal (e.g., rectangular, triangular, etc.), irregular, and the like. Pore size distribution and volume can be measured via mercury intrusion porosimetry using ASTM Standard Test D4284-07.

The pores of the porous electroactive region may be of any of a variety of suitable sizes (e.g., average cross-sectional pore diameter). For example, in some cases, the pores of the porous electroactive region can be sufficiently large to allow for the passage of liquid electrolyte into the pores of the electrode due to, for example, capillary forces. In addition, in some cases, the pores may be smaller than millimeter-scale or micron-scale pores, which may be so large that they render the electrode mechanically unstable. In some embodiments, the pores have an average cross-sectional diameter of greater than or equal to 0.2 nm, greater than or equal to 0.5 nm, greater than or equal to 1 nm, greater than or equal to 5 nm, greater than or equal to 10 nm, greater than or equal to 20 nm, greater than or equal to 30 nm, greater than or equal to 40 nm, greater than or equal to 50 nm, greater than or equal to 100 nm, or more. In some embodiments, the pores have an average cross-sectional diameter of less than or equal to 500 nm, less than or equal to 400 nm, less than or equal to 300 nm, less than or equal to 200 nm, less than or equal to 200 nm, less than or equal to 100 nm, or less. Combinations of the above-referenced ranges are also possible (e.g., greater than or equal to 0.2 nm and less than or equal to 200 nm). Other ranges are possible. The cross-sectional diameter of a pore and the average cross-sectional pore diameter of an electroactive region can be measured via mercury intrusion porosimetry using ASTM Standard Test D4284-07.

As mentioned above, electrodes and methods of preparing electrodes described herein may have or result in a porous electroactive region with a low porosity. Unexpectedly, it has been discovered, within the context of this disclosure, that electrodes having a relatively low porosity (e.g., less than or equal to 16% porosity) can exhibit increased cycle life. This discovery was unexpected in that it was originally believed that such low porosities would have decreased cycle life by limiting electrolyte penetration into the electrode. Low porosity electrodes may also advantageously increase the volumetric energy density relative to higher porosity electrodes.

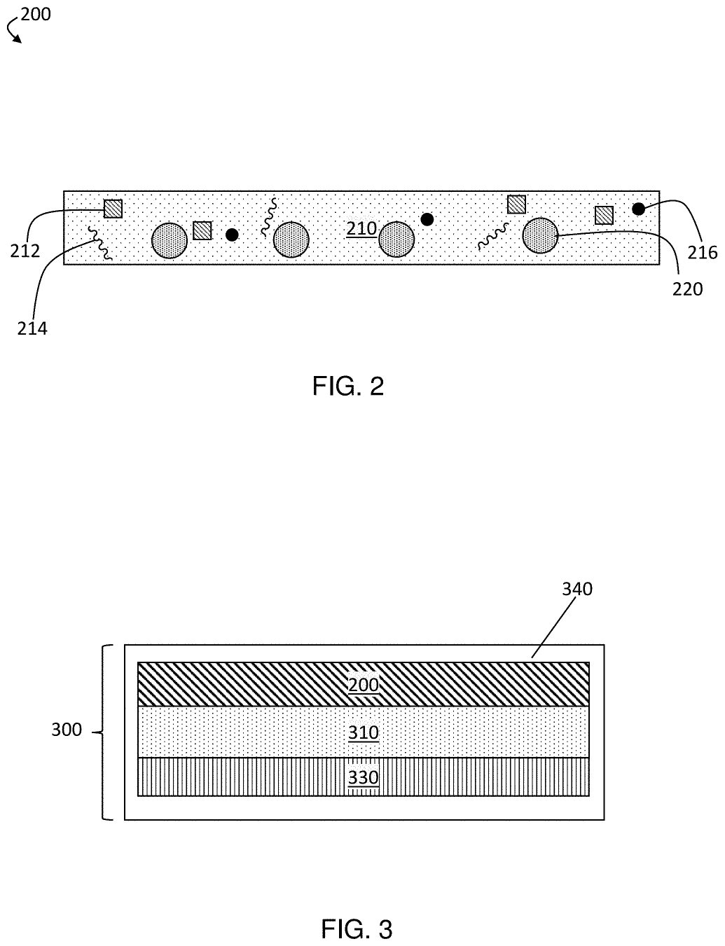

As mentioned above, electrodes described herein may include a porous electroactive region that contains a lithium intercalation compound and an electronically conductive material. A binder may also be present, in certain embodiments. As would be understood by those of ordinary skill in the art, the electroactive region of an electrode is the volume within the electrode within which the electrode active material is distributed. In the case where a lithium intercalation compound is being used as the electroactive material, the electroactive region would correspond to the volume within which the lithium intercalation compound is distributed. For example, as schematically depicted in FIG. 2, electrode 200 contains porous electroactive region 210 that includes lithium intercalation compound 212, binder 214, and electronically conductive material 216. Porous electroactive region 210 also includes one or more pores 220. In some embodiments, the one or more pores contribute to the overall porosity of the electrode.

The term “porosity” is generally used herein to describe the ratio of void volume to overall volume and is expressed as a percentage. In the case of an electroactive region, the porosity of the electroactive region can be thought of as the result of dividing the void volume of the electroactive region by the overall volume of the electroactive region and multiplying the result by 100%, where the void volume refers to the portions of a particular region that are capable of being occupied by a liquid or a gas. In the case of an electroactive region, the void volume corresponds to the portions of the volume of the electroactive region that are capable of being occupied by a liquid or a gas. The void volume of an electroactive region would not include, for example, the volume occupied by the lithium intercalation compound, the electronically conductive material (e.g., carbon black), or the binder. Void volume may be occupied by electrolyte, gases, or other liquid or gas components. The porosity of the porous electroactive region can be measured via mercury intrusion porosimetry, using a standard test such as ASTM Standard Test D4284-07.

As mentioned above, the electrodes described herein (e.g., the porous electroactive region of an electrode) may have a relatively low porosity. For example, in some embodiments, the porous electroactive region has a porosity of less than or equal to 16%, less than or equal to 15%, less than or equal to 12%, less than or equal to 10%, less than or equal to 9%, less than or equal to 8%, less than or equal to 7%, less than or equal to 6%, or less. In some embodiments, the porous electroactive region has a porosity of greater than or equal to 5%, greater than or equal to 6%, greater than or equal to 7%, or more. Combinations of the above-referenced ranges are also possible (e.g., greater than or equal to 5% and less than or equal to 16%). Other ranges are possible.

In some embodiments, an electrochemical cell comprising an electrode with a low porosity porous electroactive region may exhibit a substantial increase in cycle life. The cycle life can be determined by performing multiple charge/discharge cycles, in which each cycle is made up of one full charge and one full discharge. The cycle life corresponds to the number of cycles for which the complete discharge generates at least 67% of the capacity of the first discharge of the electrochemical cell. In certain embodiments, electrochemical cells comprising the low porosity electrodes described herein can exhibit a cycle life of at least 50 cycles, at least 75 cycles, at least 100 cycles, at least 125 cycles, at least 150 cycles, or more at a discharge current of 300 mA to 3.0 V and at a charge current of 75 mA to 4.0 V.

As described above, the porous electroactive region may include a lithium intercalation compound. Lithium intercalation compounds are compounds that are capable of reversibly inserting lithium ions at lattice sites and/or interstitial sites. In some embodiments, the lithium intercalation compound comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂, “LCO”), lithium nickel oxide (LiNiO₂), and lithium manganese oxide (LiMnO₂). In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, a non-limiting example of a suitable NMC compound is LiNi_{1/3}Mn_{1/3}Co_{1/3}O₂. In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}. In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In some embodiments, the lithium intercalation compound comprises a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the lithium intercalation compound comprises a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓMn₂₋ₓO₄, also referred to as “LMNO”). A non-limiting example of a suitable LMNO compound is LiNi_{0.5}Mn_{1.5}O₄. In some cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, a weight percentage (wt %) of lithium intercalation compound (e.g., after drying the electrode) in the porous electroactive region of the electrode is greater than or equal to 80 wt %, greater than or equal to 85 wt %, greater than or equal to 90 wt %, greater than or equal to 91 wt %, greater than or equal to 92 wt %, greater than or equal to 93 wt %, greater than or equal to 94 wt %, greater than or equal to 95 wt %, greater than or equal to 96 wt %, greater than or equal to 97 wt %, greater than or equal to 98 wt %, greater than or equal to 99 wt %, or more. In some embodiments, the weight percentage of lithium intercalation compound present in the porous electroactive region is less than or equal to 99 wt %, less than or equal to 98 wt %, less than or equal to 97 wt %, less than or equal to 96 wt %, less than or equal to 95 wt %, less than or equal to 94 wt %, less than or equal to 93 wt %, less than or equal to 92 wt %, less than or equal to 91 wt %, less than or equal to 90 wt %, or less. Combinations of the above-referenced ranges are also possible (e.g., greater than or equal to 90 wt % and less than or equal to 95 wt %). Other ranges are possible.

In some embodiments, the porous electroactive region includes a binder (e.g., a polymeric binder). The binder can contribute to the mechanical stability of the electrode, in addition to providing a matrix for other components of the porous electroactive region (e.g., the lithium intercalation compound, the electronically conductive material).

As mentioned above, the binder may comprise a polymeric binder (e.g., an organic polymeric binder). The polymeric binder can be any suitable polymer provided that the polymer provides adequate mechanical support to the porous electroactive region or the electrode. In some embodiments, the polymeric binder comprises a polyvinylidene difluoride (PVDF) polymer. However, other polymeric binders are possible. Non-limiting examples of other polymeric binders include polyether sulfone, polyether ether sulfone, polyvinyl alcohol, polyvinyl acetate, and polybenzimidazole. Additional non-limiting examples of polymeric binders include a poly(vinylidene fluoride copolymer) such as a copolymer with hexafluorophosphate, a poly(styrene)-poly(butadiene) copolymer, a poly(styrene)-poly(butadiene) rubber, carboxymethyl cellulose, and poly(acrylic acid). Other polymeric binders are possible.

In some embodiments, the weight percentage of binder (e.g., after drying the electrode) in the porous electroactive region of the electrode is greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, or more. In some embodiments, the wt % of binder in the porous electroactive region is less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, or less. Combinations of the above-referenced ranges are also possible (e.g., greater than or equal to 1 wt % and less than or equal to 3 wt %). Other ranges are possible.

According to some embodiments, the porous electroactive region includes an electronically conductive material. In some embodiments, the electronically conductive material comprises carbon, such as elemental carbon. Elemental carbon contains carbon in an oxidation state of zero. The elemental carbon can contain sp³- and/or sp²-hybrized carbon atoms. In some embodiments, the elemental carbon contains almost exclusively carbon atoms and hence contains a relatively high atomic percent (at %) of carbon atoms (e.g., 98 at % carbon, 99 at % carbon, 99.9 at %). In some embodiments, the elemental carbon contains trace amounts (e.g., less than 2 at %, less than 1 at %, less than 0.1 at %) of other elements (e.g., hydrogen, nitrogen, oxygen, sulfur), for example, on the surface to terminate dangling bonds of the elemental carbon.

In some embodiments, the electronically conductive material comprises carbon black.

In some cases, other electronically conductive materials can be used and may include, for example, other conductive carbons such as graphite fibers, graphite fibrils, graphite powder (e.g., Fluka #50870), activated carbon fibers, carbon fabrics, and non-activated carbon nanofibers, without limitation. Other non-limiting examples of electronically conductive materials include metal-coated glass particles, metal particles, metal fibers, nanoparticles, nanotubes, nanowires, metal flakes, metal powders, metal fibers, and metal meshes.

In some embodiments, a weight percentage (wt %) of the electronically conductive material (e.g., after drying the electrode) in the porous electroactive region of the electrode is greater than or equal to 1 wt %, greater than or equal to 2 wt %, greater than or equal to 3 wt %, greater than or equal to 4 wt %, greater than or equal to 5 wt %, greater than or equal to 6 wt %, greater than or equal to 7 wt %, greater than or equal to 8 wt %, greater than or equal to 9 wt %, greater than or equal to 10 wt %, or more. In some embodiments, the wt % of the electronically conductive material in the porous electroactive region is less than or equal to 10 wt %, less than or equal to 9 wt %, less than or equal to 8 wt %, less than or equal to 7 wt %, less than or equal to 6 wt %, less than or equal to 5 wt %, less than or equal to 4 wt %, less than or equal to 3 wt %, less than or equal to 2 wt %, less than or equal to 1 wt %, or less. Combinations of the above-referenced ranges are also possible (e.g., greater than or equal to 2 wt % and less than or equal to 4 wt %). Other ranges are possible.

In certain embodiments, the electronically conductive material has a bulk electronic resistivity (at 20° C.) of less than or equal to 1 ohm-meter, less than or equal to 0.1 ohm-meter, less than or equal to 0.01 ohm-meter, less than or equal to 10⁻³ ohm-m, less than or equal to 10⁻⁴ ohm-m, less than or equal to 10⁻⁵ ohm-m, less than or equal to 10⁻⁷ ohm-m, or less.

The electrodes described herein may be included as a component of an electrochemical cell. The electrochemical cell can be, in some embodiments, a rechargeable electrochemical cell. In some embodiments, the electrochemical cell is a rechargeable lithium-ion electrochemical cell.

In some embodiments, an electrochemical cell comprises a first electrode (e.g., a cathode), a second electrode (e.g., an anode), and an electrolyte region in electrochemical communication with the first electrode and the second electrode. In some embodiments, the electrolyte region can be between the first electrode and the second electrode. In some embodiments, the electrolyte region comprises a separator and a liquid electrolyte. In other embodiments, the electrolyte region can be a solid electrolyte. In FIG. 3, electrochemical cell 300 contains a first electrode 200, which can be any of the porous electrodes described above or elsewhere herein. Electrochemical cell 300 further includes electrolyte region 310 and second electrode 330. The electrochemical cell may also include, in some cases, a containment structure, such as containment structure 340.

The first electrode (e.g., the cathode) and/or the second electrode (e.g., the anode) can further comprise a current collector. For example, in some embodiments, a current collector is adjacent to the first electrode such that the current collector can remove current from and/or deliver current to the first electrode. Similarly, in some embodiments, a current collector is adjacent to the second electrode such that the current collector can remove current from and/or deliver current to the second electrode.

A wide range of current collectors are known in the art. Suitable current collectors may include, for example, metals, metal foils (e.g., aluminum foil), polymer films, metallized polymer films (e.g., aluminized plastic films, such as aluminized polyester film), electrically conductive polymer films, polymer films having an electrically conductive coating, electrically conductive polymer films having an electrically conductive metal coating, and polymer films having conductive particles dispersed therein.

In some embodiments, the current collector includes one or more conductive metals such as aluminum, copper, chromium, stainless steel and/or nickel. For example, a current collector may include a copper metal layer. In some cases, another conductive metal layer, such as titanium, may be positioned on the copper layer. Other current collectors may include, for example, expanded metals, metal mesh, metal grids, expanded metal grids, metal wool, woven carbon fabric, woven carbon mesh, non-woven carbon mesh, and carbon felt. Furthermore, a current collector may be electrochemically inactive. In other embodiments, however, a current collector may comprise an electroactive layer. For example, a current collector may include a material which is used as an electroactive layer (e.g., as an anode or a cathode such as those described herein).

A current collector may have any suitable thickness. For instance, the thickness of a current collector may be, for example, between 0.1 and 0.5 microns thick, between 0.1 and 0.3 microns thick, between 0.1 and 2 microns thick, between 1-5 microns thick, between 5-10 microns thick, between 5-20 microns thick, or between 10-50 microns thick. In some embodiments, the thickness of a current collector is, e.g., 20 microns or less, 12 microns or less, 10 microns or less, 7 microns or less, 5 microns or less, 3 microns or less, 1 micron or less, 0.5 micron or less, or 0.3 micron or less.

In some embodiments, the electrodes described herein (e.g., electrodes comprising a porous electroactive region) can be cathodes comprising cathode active material. In some embodiments, the porous electroactive region may contain any of the below-described cathode active materials. Suitable electroactive materials for use as cathode active materials in the cathodes include, but are not limited to, one or more metal oxides, one or more intercalation materials, electroactive transition metal chalcogenides, electroactive conductive polymers, sulfur, carbon and/or combinations thereof.

In some embodiments, the cathode active material comprises one or more metal oxides. In some embodiments, an intercalation cathode (e.g., a lithium-intercalation cathode) may be used. Non-limiting examples of suitable materials that may intercalate ions of an electroactive material (e.g., alkaline metal ions) include metal oxides, titanium sulfide, and iron sulfide. In some embodiments, the cathode is an intercalation cathode comprising a lithium transition metal oxide or a lithium transition metal phosphate. Additional examples include LiₓCoO₂ (e.g., Li_{1.1}CoO₂), LiₓNiO₂, LiₓMnO₂, LiₓMn₂O₄ (e.g., LiNi_{1.05}Mn₂O₄), LiₓCoPO₄, LiₓMnPO₄, LiCoₓNi₍₁₋ₓ₎O₂, and LiCoₓNi_{y}Mn_{(1-x-y)}O₂ (e.g., LiNi_{1/3}Mn_{1/3}Co_{1/3}O₂, LiNi_{3/5}Mn_{1/5}Co_{1/5}O₂, LiNi_{4/5}Mn_{1/10}Co_{1/10}O₂, LiNi_{1/2}Mn_{3/10}Co_{1/5}O₂). X may be greater than or equal to 0 and less than or equal to 2. X is typically greater than or equal to 1 and less than or equal to 2 when the electrochemical device is fully discharged, and less than 1 when the electrochemical device is fully charged. In some embodiments, a fully charged electrochemical device may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where (0<x≤1), LiMnₓNi_{y}O₄ where (x+y=2) (e.g., LiMn_{1.5}Ni_{0.5}O₄), LiNiₓCo_{y}Al_{z}O₂ where (x+y+z=1), LiFePO₄, and combinations thereof. In some embodiments, the electroactive material within the cathode comprises lithium transition metal phosphates (e.g., LiFePO₄), which can, in certain embodiments, be substituted with borates and/or silicates.

As mentioned above, electrochemical cells described herein may also include a second electrode (e.g., an anode).

The second electrode can comprise a variety of suitable materials. In some embodiments, the second electrode comprises lithium (e.g., lithium metal, a layer of lithium metal), such as lithium foil, lithium deposited onto a conductive substrate or onto a non-conductive substrate (e.g., a release layer), vacuum-deposited lithium metal, and lithium alloys (e.g., lithium-aluminum alloys and lithium-tin alloys). Lithium can be contained as one film or as several films, in some cases separated. Suitable lithium alloys for use in the aspects described herein can include alloys of lithium and aluminum, magnesium, silicium (silicon), indium, and/or tin.

In some cases, the lithium metal/lithium metal alloy may be present during only a portion of charge/discharge cycles. For example, the cell can be constructed without any lithium metal/lithium metal alloy on an anode current collector, and the lithium metal/lithium metal alloy may subsequently be deposited on the anode current collector during a charging step. In some embodiments, lithium may be completely depleted after discharging such that lithium is present during only a portion of the charge/discharge cycle.

In some embodiments, the second electrode contains greater than or equal to 50 wt % lithium, greater than or equal to 75 wt % lithium, greater than or equal to 80 wt % lithium, greater than or equal to 90 wt % lithium, greater than or equal to 95 wt % lithium, greater than or equal to 99 wt % lithium, or more. In some embodiments, the second electrode contains less than or equal to 99 wt % lithium, less than or equal to 95 wt % lithium, less than or equal to 90 wt % lithium, less than or equal to 80 wt % lithium, less than or equal to 75 wt % lithium, less than or equal to 50 wt % lithium, or less. Combinations of the above-reference ranges are also possible (e.g., greater than or equal to 90 wt % lithium and less than or equal to 99 wt % lithium). Other ranges are possible.

In some embodiments, the second electrode is an anode from which lithium ions are liberated during discharge and into which the lithium ions are integrated (e.g., intercalated) during charge. In some embodiments, the second electrode comprises a lithium intercalation compound (e.g., a compound that is capable of reversibly inserting lithium ions at lattice sites and/or interstitial sites). In some embodiments, the second electrode comprises carbon. In certain cases, the second electrode is or comprises a graphitic material (e.g., graphite). A graphitic material generally refers to a material that comprises a plurality of layers of graphene (i.e., layers comprising carbon atoms covalently bonded in a hexagonal lattice). Adjacent graphene layers are typically attracted to each other via van der Waals forces, although covalent bonds may also be present between one or more sheets in some cases. In some cases, the carbon-comprising second electrode is or comprises coke (e.g., petroleum coke). In certain embodiments, the second electrode comprises silicon, lithium, and/or any alloys of combinations thereof. In certain embodiments, the second electrode comprises lithium titanate (Li₄Ti₅O₁₂, also referred to as “LTO”), tin-cobalt oxide, or any combinations thereof.

The second electrode may be any suitable thickness. In some embodiments, the second electrode has a thickness of greater than or equal to 10 micrometers (μm), greater than or equal to 20 μm, greater than or equal to 30 μm, greater than or equal to 40 μm, greater than or equal to 50 μm, greater than or equal to 75 μm, greater than or equal to 100 μm, or more. In some embodiments, the second electrode has a thickness of less than or equal to 100 μm, less than or equal to 75 μm, less than or equal to 50 μm, less than or equal to 40 μm, less than or equal to 30 μm, less than or equal to 20 μm, less than or equal to 10 μm, or less. Combinations of the above-referenced ranges are also possible (e.g., greater than or equal to 10 μm and less than or equal to 100 μm). Other ranges are possible.

As noted above, electrochemical cells described herein may include an electrolyte region. In some embodiments, the electrolyte region includes a separator that physically separates a first electrode (e.g., a cathode) and a second electrode (e.g., an anode) and a liquid electrolyte. However, in some embodiments, the electrolyte region includes a solid electrolyte, as described in more detail below.

The electrolyte can function as a medium for the storage and transport of ions, and in the special case of solid electrolytes and gel electrolytes, these materials may additionally function as a separator between the first electrode (e.g., a cathode) and a second electrode (e.g., an anode). Any liquid, solid, or gel material capable of storing and transporting ions may be used, so long as the material facilitates the transport of ions (e.g., lithium ions) between an anode and the cathode. The electrolyte is electronically non-conductive to prevent short circuiting between an anode and a cathode. In some embodiments, the electrolyte may comprise a non-solid electrolyte.

In some embodiments, the electrolyte comprises a fluid that can be added at any point in the fabrication process. In some cases, the electrochemical cell may be fabricated by providing a first electrode and a second electrode, applying an anisotropic force component normal to the active surface of the second electrode, and subsequently adding the fluid electrolyte such that the electrolyte is in electrochemical communication with the first electrode and the second electrode. In other cases, the fluid electrolyte may be added to the electrochemical cell prior to or simultaneously with the application of an anisotropic force component, after which the electrolyte is in electrochemical communication with the first electrode and the second electrode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. Pat. No. 8,617,748, issued on Dec. 31, 2013 and entitled “Separation of Electrolytes,” which is incorporated herein by reference in its entirety.

Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes, for example, in lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and in some cases, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolyte of the electrochemical cells described herein include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, LiN(SO₂CF₃)₂, and lithium bis(fluorosulfonyl)imide (LiFSI). Other electrolyte salts that may be useful include lithium polysulfides (Li₂Sₓ), and lithium salts of organic polysulfides (LiSₓR)ₙ, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂⁻, bis (trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

In some embodiments, the electrochemical cell includes a separator between the first electrode and the second electrode. The separator may be a solid non-electronically conductive or insulative material which separates or insulates the first electrode and the second electrode from each other preventing short circuiting, and which permits the transport of ions between the first electrode and the second electrode. That is to say, the separator can be electronically insulating but ionically conductive. In some embodiments, the separator can be porous and may be permeable to the liquid electrolyte.

The pores of the separator may be partially or substantially filled with liquid electrolyte. Separators may be supplied as porous free-standing films which are interleaved with the first electrode and the second electrode during the fabrication of cells. Alternatively, the separator layer may be applied directly to the surface of one of the electrodes, for example, as described in PCT Publication No. WO 1999/033125 to Carlson et al. and in U.S. Pat. No. 5,194,341 to Bagley et al.

The separator may include a variety of suitable materials. For example, in some embodiments, the separator comprises a polymer. Examples of suitable separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this disclosure are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545. Solid electrolytes and gel electrolytes may also function as a separator in addition to their electrolyte function.

The separator may be any suitable thickness that provides physical separation between the first electrode and the second electrode. In some embodiments, the separator has a thickness of greater than or equal to 1 μm, greater than or equal to 2 μm, greater than or equal to 3 μm, greater than or equal to 4 μm, greater than or equal to 5 μm, greater than or equal to 6 μm, greater than or equal to 9 μm, greater than or equal to 12 μm, greater than or equal 15 μm, greater than or equal to 20 μm, greater than or equal to 25 μm, or more. In some embodiments, the separator has a thickness of less than or equal to 25 μm, less than or equal to 20 μm, less than or equal to 15 μm, less than or equal to 12 μm, less than or equal to 9 μm, less than or equal to 6 μm, less than or equal to 5 μm, less than or equal to 4 μm, less than or equal to 3 μm, less than or equal to 2 μm, less than or equal to 1 μm, or less. Combinations of the above-referenced ranges are also possible (e.g., greater than or equal to 3 μm and less than or equal to 12 μm). Other ranges are possible.

Electrochemical cells and/or electrodes described herein may be under an applied anisotropic force. As understood in the art, an “anisotropic force” is a force that is not equal in all directions. In some embodiments, the electrochemical cells and/or the electrodes can be configured to withstand an applied anisotropic force (e.g., a force applied to enhance the morphology of an electrode within the cell) while maintaining their structural integrity. The electrodes described herein may be a part of an electrochemical cell that is adapted and arranged such that, during at least one period of time during charge and/or discharge of the cell, an anisotropic force with a component normal to the active surface of an electrode (e.g., a porous electroactive region of an electrode) within the electrochemical cell is applied to the cell.

In some such cases, the anisotropic force comprises a component normal to an active surface of an electrode (e.g., a first electrode, a second electrode) within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill will understand other examples of these terms, especially as applied within the description of this disclosure. In the case of a curved surface (for example, a concave surface or a convex surface), the component of the anisotropic force that is normal to an active surface of an electrode may correspond to the component normal to a plane that is tangent to the curved surface at the point at which the anisotropic force is applied. The anisotropic force may be applied, in some cases, at one or more pre-determined locations, in some cases distributed over the active surface of an electrode. In some embodiments, the anisotropic force is applied uniformly over the active surface of the first electrode (e.g., a porous electrode) and/or the second electrode (e.g., an anode).

Any of the electrochemical cell properties and/or performance metrics described herein may be achieved, alone or in combination with each other, while an anisotropic force is applied to the electrochemical cell (e.g., during charge and/or discharge of the cell). In some embodiments, the anisotropic force applied to the electrode or to the electrochemical cell (e.g., during at least one period of time during charge and/or discharge of the cell) can include a component normal to an active surface of an electrode (e.g., an active surface of a lithium metal containing electrode and/or an active surface of a porous electroactive region of an electrode).

In some embodiments, the component of the anisotropic force that is normal to the active surface of the electrode defines a pressure of greater than or equal to 1 kg_{f}/cm², greater than or equal to 2 kg_{f}/cm², greater than or equal to 4 kg_{f}/cm², greater than or equal to 6 kg_{f}/cm², greater than or equal to 7.5 kg_{f}/cm², greater than or equal to 8 kg_{f}/cm², greater than or equal to 10 kg_{f}/cm², greater than or equal to 12 kg_{f}/cm², greater than or equal to 14 kg_{f}/cm², greater than or equal to 16 kg_{f}/cm², greater than or equal to 18 kg_{f}/cm², greater than or equal to 20 kg_{f}/cm², greater than or equal to 22 kg_{f}/cm², greater than or equal to 24 kg_{f}/cm², greater than or equal to 26 kg_{f}/cm², greater than or equal to 28 kg_{f}/cm², greater than or equal to 30 kg_{f}/cm², greater than or equal to 32 kg_{f}/cm², greater than or equal to 34 kg_{f}/cm², greater than or equal to 36 kg_{f}/cm², greater than or equal to 38 kg_{f}/cm², greater than or equal to 40 kg_{f}/cm², greater than or equal to 42 kg_{f}/cm², greater than or equal to 44 kg_{f}/cm², greater than or equal to 46 kg_{f}/cm², greater than or equal to 48 kg_{f}/cm², or more. In some embodiments, the component of the anisotropic force normal to the active surface may, for example, define a pressure of less than or equal to 50 kg_{f}/cm², less than or equal to 48 kg_{f}/cm², less than or equal to 46 kg_{f}/cm², less than or equal to 44 kg_{f}/cm², less than or equal to 42 kg_{f}/cm², less than or equal to 40 kg_{f}/cm², less than or equal to 38 kg_{f}/cm², less than or equal to 36 kg_{f}/cm², less than or equal to 34 kg_{f}/cm², less than or equal to 32 kg_{f}/cm², less than or equal to 30 kg_{f}/cm², less than or equal to 28 kg_{f}/cm², less than or equal to 26 kg_{f}/cm², less than or equal to 24 kg_{f}/cm², less than or equal to 22 kg_{f}/cm², less than or equal to 20 kg_{f}/cm², less than or equal to 18 kg_{f}/cm², less than or equal to 16 kg_{f}/cm², less than or equal to 14 kg_{f}/cm², less than or equal to 12 kg_{f}/cm², less than or equal to 10 kg_{f}/cm², less than or equal to 8 kg_{f}/cm², less than or equal to 6 kg_{f}/cm², less than or equal to 4 kg_{f}/cm², less than or equal to 2 kg_{f}/cm², or less. Combinations of the above-referenced ranges are also possible (e.g., greater than or equal to 1 kg_{f}/cm² and less than or equal to 50 kg_{f}/cm²). Other ranges are possible.

The anisotropic forces applied during at least a portion of charge and/or discharge may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

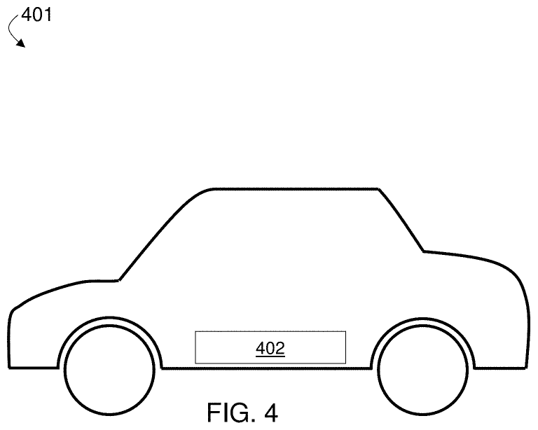

In some embodiments, the electrodes described herein can be part of electrochemical cells (e.g., rechargeable electrochemical cells). In some embodiments, the electrochemical cells can be incorporated into battery packs (e.g., comprising rechargeable batteries). Electrochemical cells and/or battery packs described in this disclosure can be used to provide power to an electric vehicle or otherwise be incorporated into an electric vehicle. As a non-limiting example, electrochemical cells and/or battery packs described in this disclosure can, in certain embodiments, be used to provide power to a drive train of an electric vehicle. The vehicle may be any suitable vehicle, adapted for travel on land, sea, air, and/or space. For example, the vehicle may be an automobile, truck, motorcycle, boat, helicopter, airplane, spacecraft and/or any other suitable type of vehicle. FIG. 4 shows a cross-sectional schematic diagram of electric vehicle 401 in the form of an automobile comprising battery pack 402, in accordance with some embodiments. Battery pack 402 can, in some instances, provide power to a drive train of electric vehicle 401.

It should be understood that when a portion (e.g., layer, structure, region) is “on”, “adjacent”, “above”, “over”, “overlying”, or “supported by” another portion, it can be directly on the portion, or an intervening portion (e.g., layer, structure, region) also may be present. Similarly, when a portion is “below” or “underneath” another portion, it can be directly below the portion, or an intervening portion (e.g., layer, structure, region) also may be present. A portion that is “directly on”, “directly adjacent”, “immediately adjacent”, “in direct contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, and entitled “PASSIVATING AGENTS FOR ELECTROCHEMICAL CELLS”; U.S. Publication No. US-2018-0277850-A1, published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1, published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1, published on Nov. 23, 2017, filed as U.S. application Ser. No. 15/599,595 on May 19, 2017, and entitled “PROTECTIVE LAYERS FOR ELECTRODES AND ELECTROCHEMICAL CELLS”; U.S. Publication No. US-2019-0088958-A1, published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1, published on Nov. 14, 2019, filed as U.S. application Ser. No. 16/470,708 on Jun. 18, 2019, and entitled “PROTECTIVE LAYERS COMPRISING METALS FOR ELECTROCHEMICAL CELLS”; U.S. Publication No. US-2017-0200975-A1, published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1, published Dec. 6, 2018, filed as U.S. application Ser. No. 15/988,182 on May 24, 2018, and entitled “IONICALLY CONDUCTIVE COMPOUNDS AND RELATED USES”; U.S. Publication No. US-2018-0254516-A1, published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1, published Feb. 6, 2020, filed as U.S. Application No. 16,527,903 on Jul. 31, 2019, and entitled “MULTIPLEXED CHARGE DISCHARGE BATTERY MANAGEMENT SYSTEM”; U.S. Publication No. US-2020-0220146-A1, published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1, published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1, published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”.

U.S. Provisional Patent Application No. 63/121,265, filed Dec. 4, 2020, and entitled “Low Porosity Electrodes and Related Methods” is incorporated herein by reference in its entirety for all purposes.

The following examples are intended to illustrate certain embodiments of the present invention, but do not exemplify the full scope of the invention.

### Example 1

The following example describes the preparation of NCM811 cathodes with varying porosities and their charge/discharge cycling performance.

An NMP solvent-based cathode slurry was prepared containing NCM811 material, PVDF, and carbon black to form a deposit. The deposit was coated on Al foil substrate. The coated cathode deposit was dried at 130° C. After drying, the dry cathode formulation contained 94.5 wt % of active cathode material NCM811, 2.5 wt % of PVDF binder, 3 w % of conductive carbon black.

To vary the cathode porosity, a flat compression technique was applied with pressure ranging from 0 to 26.5 ton/cm² and temperature ranging from 20° C. to 170° C. The flat compression technique used an ABEX Denison (model 11875) hydraulic press to compress pre-coated cathodes placed between polished, hard steel plates and compressed for 0.5 to 5 minutes at the desired force. Cathode porosity after compression was measured via mercury intrusion porosimetry using ASTM Standard Test D4284-07.

The compressed cathodes were tested in the pouch cells with 50 μm thick Li foil as an anode and 9 μm thick polyolefin separator. Each cell had 99.4 cm² of active electrode area and contained 0.5 mL of electrolyte. The electrolyte formulation included LiPF₆ (12.5 wt %), fluoroethylene carbonate (17.5 wt %), and dimethyl carbonate (70.1 wt %).

During charge/discharge testing, the cells were subjected to 12 kg_{f}/cm² of pressure via the application of an anisotropic force. Charge/discharge testing was performed at a charge current of 75 mA to 4.4 V and discharge current of 300 mA to 3.0 V. Initial cell capacity was 105 mAh. Cells were cycled to a cutoff capacity of 70 mAh, and cycle life was determined at this point. Three cells were cycled for a given cathode porosity, and cycle life is reported as the average (mean) of these 3 cells.

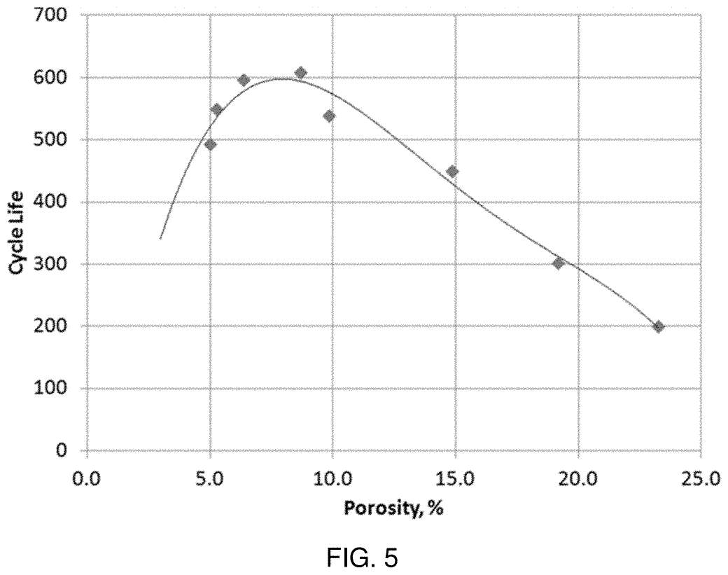

Compression parameters, porosity data, and cell cycling data are summarized in the Table 1, and FIG. 5 shows impact of the cathode porosity on cycle life.

TABLE 1
Cathode porosity and cells cycling data.

| | | Total | Average | | |
|---|---|---|---|---|---|
| | Pressure | Intrusion | Pore | | |
| Pressure | Temperature | Volume | Diameter | Porosity | Cycle |
| T/cm² | ° C. | mL/g | μm | % | Life |
| 0 | 20 | 0.109 | 0.328 | 23.2 | 200 |
| 4 | 20 | 0.079 | 0.225 | 19.2 | 303 |
| 8 | 20 | 0.060 | 0.166 | 14.8 | 450 |
| 15 | 20 | 0.043 | 0.100 | 9.8 | 540 |
| 20 | 20 | 0.035 | 0.074 | 8.7 | 609 |
| 26.5 | 20 | 0.030 | 0.080 | 6.3 | 597 |
| 26.5 | 150 | 0.022 | 0.079 | 5.2 | 550 |
| 26.5 | 170 | 0.021 | 0.095 | 5.0 | 493 |

Data in Table 1 and FIG. 5 show that performance was enhanced when the porosity was from 5 to 15%. In addition, performance was substantially enhanced when the average pore diameter was below 0.2 micrometers.

### Example 2

The following example describes the preparation of LCO and LFP cathodes and their charge/discharge performance at varying porosities.

NMP solvent-based cathode slurries were deposited on to aluminum metal foil substrates. Coated cathodes were dried at 130° C. The dry cathode formulations included 94.5 wt % of active cathode material (LCO or LFP), 2.5 wt % of PVDF binder, and 3 wt % of conductive carbon black.

To vary the cathode porosity, a flat compression technique was used. Cathode porosity after compression was measured via mercury intrusion porosimetry.

All compressed cathodes were tested in pouch cells with 50 μm thick Li foil as a negative electrode with 9 μm thick polyolefin separator. Each cell had an active electrode area of 99.4 cm² and contained 0.5 mL of electrolyte. The electrolyte formulation was LiPF₆ (12.5 wt %) fluoroethylene carbonate (17.5 wt %), and dimethyl carbonate (70.1 wt %).

During charge/discharge testing, the cells were subjected to 12 kg_{f}/cm² of pressure via the application of an anisotropic force. Charge/discharge testing was performed at a charge current of 75 mA to 4.4 V and a discharge current of 300 mA to 3.0 V for LCO cells and at a charge current of 75 mA to 4.0 V and a discharge current of 300 mA to 2.5 V for LFP cells.

Initial cell capacity for the cells containing LCO cathodes was 403 mAh. Cells were cycled to a cutoff capacity of 250 mAh and cycle life was determined at this point. Three cells were cycled for a given cathode porosity, and cycle life is reported as the average (mean) over these 3 cells.

Compression parameters, porosity data, and cell cycling data for LCO cathodes is summarized in the Table 2.

TABLE 2
LCO cathode porosity and cell cycling data.

| | | Total | Average | | |
|---|---|---|---|---|---|
| | Pressure | Intrusion | Pore | | |
| Pressure | Temperature | Volume | Diameter | Porosity | Cycle |
| T/cm² | ° C. | mL/g | μm | % | Life |
| 0 | 20 | 0.085 | 0.105 | 24.3 | 132 |
| 4 | 20 | 0.033 | 0.0384 | 12.3 | 144 |
| 8 | 20 | 0.027 | 0.0364 | 10.0 | 160 |
| 12 | 20 | 0.024 | 0.0347 | 9.4 | 152 |
| 15.6 | 20 | 0.021 | 0.0521 | 7.7 | 143 |

For LFP, initial cell capacity was 124 mAh. Cells were cycled to a cutoff capacity of 70 mAh, and cycle life was determined at this point. Three cells were cycled for a given cathode porosity, and cycle life is reported as the average (mean) of these 3 cells. The results for LFP are shown in Table 3.

TABLE 3
LFP cathode porosity and cell cycling data

| | | Total | Average | | |
|---|---|---|---|---|---|
| | Pressure | Intrusion | Pore | | |
| Pressure | Temperature | Volume | Diameter | Porosity | Cycle |
| T/cm² | ° C. | mL/g | μm | % | Life |
| 0 | 20 | 0.151 | 0.0622 | 29.9 | 1083 |
| 15.6 | 20 | 0.064 | 0.0275 | 15.8 | 1316 |

The LCO and LFP cell data further demonstrate that a reduction of the cathode porosity to 15-16% and below is beneficial for cycle life.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrode, comprising:
a porous electroactive region, the porous electroactive region comprising:
a lithium intercalation compound, and
an electronically conductive material;
wherein the porous electroactive region has a porosity of less than or equal to 16%.

2. An electrochemical cell, comprising:
a first electrode comprising a porous electroactive region, the porous electroactive region comprising:
a lithium intercalation compound, and
an electronically conductive material;
wherein the porous electroactive region has a porosity of less than or equal to 16%;
a second electrode; and
an electrolyte in electrochemical communication with the first electrode and the second electrode.

3. The electrode of claim 1, wherein the porous electroactive region has an average cross-sectional pore diameter of less than or equal to 200 nanometers.

4. An electrode, comprising:
a porous electroactive region, the porous electroactive region comprising:
a lithium intercalation compound, and
an electronically conductive material;
wherein the porous electroactive region has an average cross-sectional pore diameter of less than or equal to 200 nanometers.

5. An electrochemical cell, comprising:
a first electrode comprising a porous electroactive region, the porous electroactive region comprising:
a lithium intercalation compound, and
an electronically conductive material;
wherein the porous electroactive region has an average cross-sectional pore diameter of less than or equal to 200 nanometers;
a second electrode; and
an electrolyte in electrochemical communication with the first electrode and the second electrode.

6. The electrode of claim 4, wherein the porous electroactive region has a porosity of less than or equal to 16%.

7. The electrochemical cell of claim 2, wherein the electrolyte comprises a liquid electrolyte.

8. The electrode of claim 1, wherein the porous electroactive region further comprises a binder.

9. The electrode of claim 8, wherein the binder comprises a polymeric binder.

10. The electrode of claim 8, wherein the binder comprises polyvinylidene difluoride.

11. The electrode of claim 1, wherein the lithium intercalation compound comprises a nickel cobalt manganese (NCM) lithium intercalation compound.

12. The electrode of claim 1, wherein the porous electroactive region has a porosity of less than or equal to 10%.

13. The electrode of claim 1, wherein the porous electroactive region has a porosity of greater than or equal to 5%.

14. The electrode of claim 1, wherein the porous electroactive region has a porosity of greater than or equal to 7%.

15. The electrode of claim 1, wherein the electronically conductive material comprises carbon.

16. The electrode of claim 15, wherein the carbon comprises elemental carbon.

17. The electrode of claim 16, wherein the carbon comprises carbon black.

18. The electrode of claim 1, wherein the first electrode further comprises a current collector.

19. The electrode of claim 18, wherein the current collector comprises a metal.

20. The electrochemical cell of claim 2, wherein the electrochemical cell is under an applied anisotropic force having a component normal to an active surface of the second electrode.

21. The electrochemical cell of claim 20, wherein the applied anisotropic force defines a pressure of greater than or equal to 7.5 kg_{f}/cm².

22. The electrochemical cell of claim 2, wherein the second electrode comprises lithium metal.

23. The electrochemical cell of claim 22, wherein the lithium metal is part of a lithium metal alloy.

24. The electrochemical cell of claim 22, wherein the lithium metal is part of a layer of metallic lithium.

25. A battery pack comprising the electrode of claim 1.

26. An electric vehicle comprising the battery pack of claim 25.

27. A method of preparing an electrode comprising a porous electroactive region, the method comprising:
depositing a lithium intercalation compound and an electronically conductive material onto a substrate to form a deposit;
wherein the porous electroactive region has a porosity of less than or equal to 16%.

28. The method of claim 27, wherein the porous electroactive region has an average cross-sectional pore diameter is less than or equal to 200 nanometers.

29. A method of preparing an electrode comprising a porous electroactive region, the method comprising:
depositing a lithium intercalation compound and an electronically conductive material onto a substrate to form a deposit;
wherein the porous electroactive region has an average cross-sectional pore diameter of less than or equal to 200 nanometers.

30. The method of claim 29, wherein the porous electroactive region has a porosity of less than or equal to 16%

31. The method of claim 27, wherein the depositing further comprises depositing a liquid.

32. The method of claim 31, further comprising removing at least a portion of the liquid from the deposit to form the porous electroactive region.

33. The method of claim 32, wherein the removing at least a portion of the liquid comprises removing at least 90 wt % of the liquid from the deposit.

34. The method of claim 32, wherein, after removing at least a portion of the liquid, at least 80 wt % of the porous electroactive region is composed of the lithium intercalation compound.

35. The method of claim 32, wherein, after removing at least a portion of the liquid, at least 1 wt % of the porous electroactive region is composed of the electronically conductive material.

36. The method of claim 27, wherein the depositing further comprises depositing a binder.

37. The method of claim 36, wherein, after removing at least a portion of the liquid, at least 1 wt % of the porous electroactive region is composed of the binder.

38. The method of claim 27, further comprising compressing the deposit.

39. The method of claim 38, wherein compressing the deposit comprises applying a force of greater than or equal to 0.5 ton/cm² to the deposit.

40. The method of claim 38, wherein compressing the deposit comprises applying a force of less than or equal to 100 ton/cm² to the deposit.

41. The method of claim 27, further comprising placing the deposit under vacuum.

42. The method of claim 27, further comprising heating the deposit.

43. The method of claim 42, wherein the heating comprises heating to greater than or equal to 100° C.

44. The method of claim 42, wherein the heating comprises heating to less than or equal to 200° C.

45. The method of claim 42, wherein the heating step occurs for at least 1 hour.
